(19) United States
(12) Patent Application Publication
(10) Pub. No.: US 2014/0033134 A1
(43) Pub. Date: Jan. 30, 2014

(54) VARIOUS GESTURE CONTROLS FOR INTERACTIONS IN BETWEEN DEVICES

(71) Applicants: Kim P. Pimmel, San Francisco, CA (US); Marcos Weskamp, San Francisco, CA (US); Jon Lorenz, San Francisco, CA (US)

(72) Inventors: Kim P. Pimmel, San Francisco, CA (US); Marcos Weskamp, San Francisco, CA (US); Jon Lorenz, San Francisco, CA (US)

(73) Assignee: Adobe Systems Incorporated, San Jose, CA (US)

(21) Appl. No.: 12/271,864

(22) Filed: Nov. 15, 2008

(51) Int. Cl. G06F 3/01

(52) U.S. Cl. 715/863

(57) ABSTRACT

In some example embodiments, a system and method is shown that includes joining a first device to an asset sharing session to access an asset with the first device. Additionally, a system and method is shown for receiving gesture-based input via the first device, the gesture-based input relating to the asset. Further, a system and method is shown for sharing the asset with a second device, participating in the asset sharing session, based on the gesture-based input.

### COPYRIGHT

A portion of the disclosure of this document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright © 2008, Adobe Systems Incorporated. All Rights Reserved.

### TECHNICAL FIELD

The present application relates generally to the technical field of algorithms and programming and, in one specific example, Graphical User Interfaces (GUIs).

### BACKGROUND

A touch screen is a display which can detect the presence and location of a touch within the display area associated with a device. This touch may be a finger or hand, or may be a passive object, such as a stylus. A touch screen may be used as an input device to initiate the execution of a software application.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, illustrating the intersection between user devices and a context.

FIG. 2 is a diagram of a system, according to an example embodiment, used to retrieve an environment for use in participating in a context.

FIG. 3 is a diagram of a Personal Digital Assistant (PDA), according to an example embodiment, illustrating a palm-pull gesture used to retrieve an asset.

FIG. 4 is a diagram of a PDA, according to an example embodiment, illustrating a palm-push gesture to transmit an asset.

FIG. 5 is a diagram of a PDA, according to an example embodiment, illustrating a flick gesture to transmit an asset.

FIG. 6 is a diagram of a PDA, according to an example embodiment, illustrating transmitting graffiti-style text with a graffiti-style gesture.

FIG. 7 is a diagram of a PDA, according to an example embodiment, illustrating a two-finger gesture used to transmit an asset.

FIG. 8 is a block diagram of a PDA, according to an example embodiment, that includes functionality that enables the PDA to interact with other devices in a context, environment, or session.

FIG. 9 is a block diagram of a computer system, according to an example embodiment, used to share an asset based upon input in the form of a gesture.

FIG. 10 is a block diagram of a computer system, according to an example embodiment, used to distribute an asset based upon the generation of a gesture.

FIG. 11 is a flow chart illustrating a method, according to an example embodiment, used to share an asset based upon input in the form of a gesture.

FIG. 12 is a flow chart illustrating a method, according to an example embodiment, used to distribute an asset based upon a gesture.

FIG. 13 is a dual-stream flow chart illustrating a method, according to an example embodiment, used to request and receive an environment, and to generate an environment update.

FIG. 14 is a dual-stream flow chart illustrating a method, according to an example embodiment, used for the establishment of an asset sharing session.

FIG. 15 is a dual-stream flow chart illustrating a method, according to an example embodiment, used to facilitate content streaming as part of an asset sharing session.

FIG. 16 is a flow chart illustrating the execution of operation, according to an example embodiment, that provides an asset for processing.

FIG. 17 is a flow chart illustrating an operation, according to an example embodiment, that determines a vector of a gesture.

FIG. 18 is a tri-stream flow chart illustrating the execution of an operation, according to an example embodiment, used to transfer an asset based upon a gesture.

FIG. 19 is a Relational Data Schema (RDS), according to an example embodiment.

FIG. 20 shows a diagrammatic representation of a machine in the form of a computer system, according to an example embodiment, that executes a set of instructions to perform any one or more of the methodologies discussed herein.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description which follow are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

In some example embodiments, a system and method is illustrated for allowing assets to be distributed amongst devices in a network using gestures made with respect to a touch screen associated with a device. Assets include digital content (e.g., content) in the form of images, text files, or other suitable formatted data. Assets also include software components, executable software files, or other suitable formatted files that facilitate functionality associated with the device. Distribution amongst device in a network includes transmitting from one device to another device directly, or by way a various intermediate devices such as access layer network devices, distribution layer network devices, core layer network devices, and one or more servers associated therewith. In one example embodiment, distribution is facilitated where a device is part of a session in which one or more additional devices participate. Distribution may be facilitated through a context, and associated environment, through which the devices in the network interact. A gesture is an interaction between a finger, hand, or passive object and a touch screen, where the gesture has a particular form in relation to the touch screen.

In some example embodiments, a touch sensitive display (e.g. a touch screen) is implemented as part of one of the devices in the network. This device may be hand held, and may include a cell phone, Personal Digital Assistant (PDA), smart phone, or other suitable device. The touch screen may use one of more of the following technologies including resistive screen technology, surface acoustic wave technology, capacitive screen technology, strain gauge screen technology, optical imaging screen technology, dispersive signal screen technology, or acoustic pulse recognition screen technology. Displayed on the touch screen is a visual indicium (e.g., an icon) representing one or more devices that are participating in a session, or in a context with the device with which the touch screen is associated. Through using a gesture made in relation to the touch screen, the distribution of an asset to the one or more devices is facilitated. These one or more devices may be referred to as a target device herein. The source of this asset may be the device, or a server residing in the network to which the device and the target device are operatively connected. Operatively connected includes a physical or logical connection between the device, target device and the server.

In some example embodiments, gestures include a palm-pull gesture, palm-push gesture, a flick gesture, a graffiti-style gesture, a two-finger gesture, or other suitable gesture made in relation to the icon representing the target device on the touch screen. These gestures are collectively referenced herein as gesture based input. These gestures are for illustrative purposes, and other gestures may be used to distribute an asset to a target device as it appears on a touch screen. Further, while the touch screen receives these gestures from a non-passive object (e.g., a human hand), passive objects may be used in lieu of or in combination with non-passive objects to facilitate the distribution of an asset to a target device. For example, a hand may use a stylus to interact with the touch screen.

### Example System

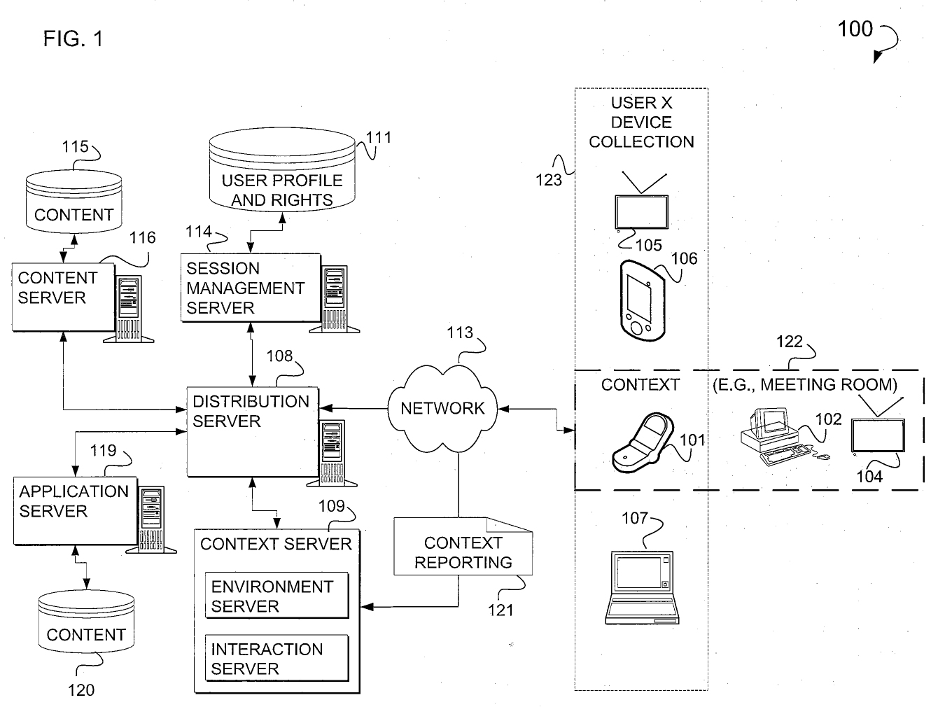

FIG. 1 is a diagram of an example system 100 illustrating the intersection between user devices and a context. Shown is a user device collection, referenced herein at 123, that includes a number of devices. These devices utilized by a user include, for example, a television 105, PDA 106, cell phone 101, and laptop computer (e.g., “laptop”) 107. In some example embodiments, one or more of these devices may participate in a context, referenced herein at 122, with other devices. These other devices include a computer 102 and a television 104. Within the context 122, the cell phone 101, computer 102, and television 104 may share an asset such as content or an application. One or more of the various devices in the context 122 may engage in context reporting through the generation of a context report 121. The context report 121 includes information relating to the devices and users participating in the context 122. The context report 121 is transmitted across the network 113 and is received by, for example, the distribution server 108. The context report 121 may be formatted using an eXtensible Markup Language (XML). The network 113 may be an Internet, a Local Area Network (LAN), a Wide Area Network (WAN), or some other suitable type of network as associated topology.

In some example embodiments, operatively connected to the network 113, is the previously referenced distribution server 108. Operatively connected includes a physical or logical connection. Operatively connected to the distribution server 108 may be a session management server 114, a context server 109, a content server 116, and an application server 119. These various servers (e.g., 108, 114, 109, 116, and 119) may interact via a cloud computing paradigm. Additionally, these various servers may be implemented on a single computer system, or multiple computer systems. In some example embodiments, the distribution server is used to manage data flowing from the context 122, and to route this data. The context server 109 includes an environment server and an interaction server. The interaction server tracks the interactions between devices in the context 122. Interactions include the sharing of assets between devices in the context 122. The environment server tracks the environment within which the interaction occurs. The environment includes data relating to the interaction such as the physical location of the devices participating in the context 122, the time and date of participation by the devices within the context 122, the size and type of assets shared, and other suitable information. The session management server 114 is used to establish and manage an asset sharing session (e.g., a session). A session is an environment that is uniquely identified via a unique numeric identifier (e.g., a session ID) so as to manage participants in the session. Participants may use a session ID in combination with a user ID and/or device ID to facilitate their participation in a session. Operatively connected to the session management server 114 is a user profile and rights data store 111 that includes the session ID, the user ID, and/or device ID. Right include legal rights associated with an asset and its use. Additionally, illustrated is the content server 116 that serves an asset in the form of content. This content is stored in the content data base 115 that is operatively connected to the content server 116. Additionally, the application server 119 is shown that is used to serve software applications. These applications are stored in the content database 120. These applications may be used to enhance, augment, supplement, or facilitate the functionality of one or more of the devices participating in the context 122.

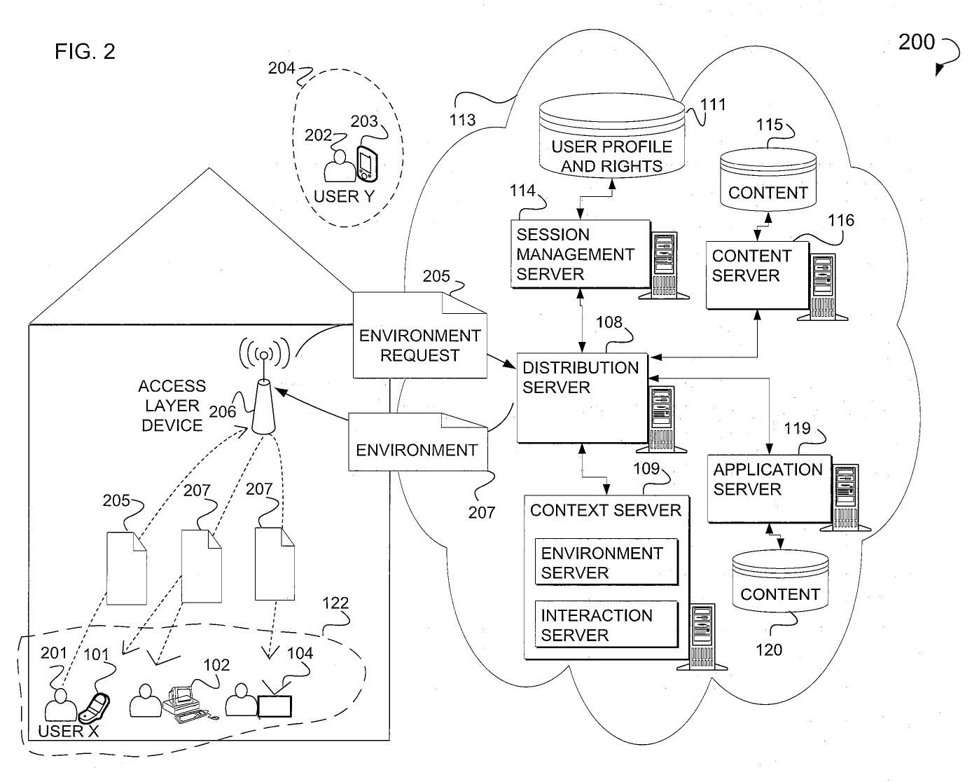

FIG. 2 is a diagram of an example system 200 used to retrieve an environment for use in participating in a context. Shown is a user 201, referenced as “user x,” that is associated with the cell phone 101. This user 201 is also associated with the user device collection 123. Further, shown is the computer 102 and television 104. As previously illustrated in FIG. 1, the cell phone 101, computer 102, and television 104 all participate in the context 122. This context may be in the form of a meeting occurring in a physical structure. In some example embodiments, the user 201 generates an environment request 205 that is received by an access layer device 206. This access layer device 206 transmits this environment request 205 across the network 113. The environment request 205 may include a request for the relative physical location of context participants. The distribution server 108, or one of the other servers (e.g., 108, 114, 109, and 116), may transmit an environment 207. This environment 207 may be distributed by the access layer device 206 to one or more of the context participants (e.g., the cell phone 101, computer 102, or television 104). Additionally, illustrated is a user 202, referenced as a “user y.” This user 202 may have their own context 204 in which the example PDA 203 participates. In some example embodiments, the content 204 and context 122 may be combined together to form a single context. This combination of contexts may occur where the PDA 203 joins the context 122.

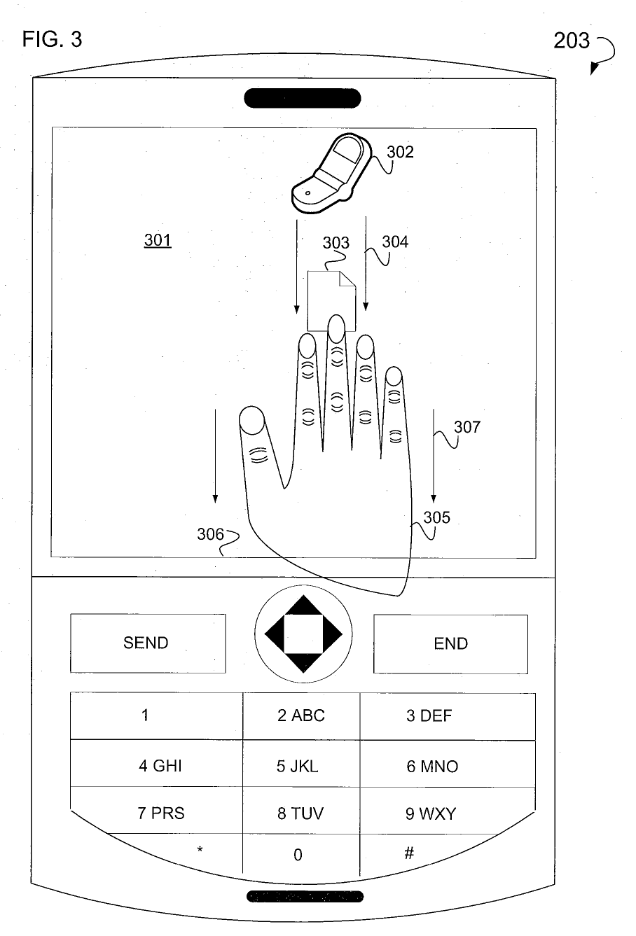

FIG. 3 is a diagram of an example PDA 203 illustrating a palm-pull gesture used to retrieve an asset. Shown is a touch screen 301 associated with the PDA 203. This touch screen 301 receives input from, for example, a palm that is a part of a hand 305. This palm engages the touch screen 301 in a palm-pull gesture away from an icon 302 representing, for example, the cell phone 101. This palm pull is used to pull the asset icon 303 (e.g., representing a file) from a device represented at the icon 302. This asset icon 303 is pulled away relative to the icon 302 and towards the bottom of the touch screen 301, where this bottom is referenced at 306. The direction of this palm-pull gesture is denoted at 304 and 307, and the arrows illustrated therein.

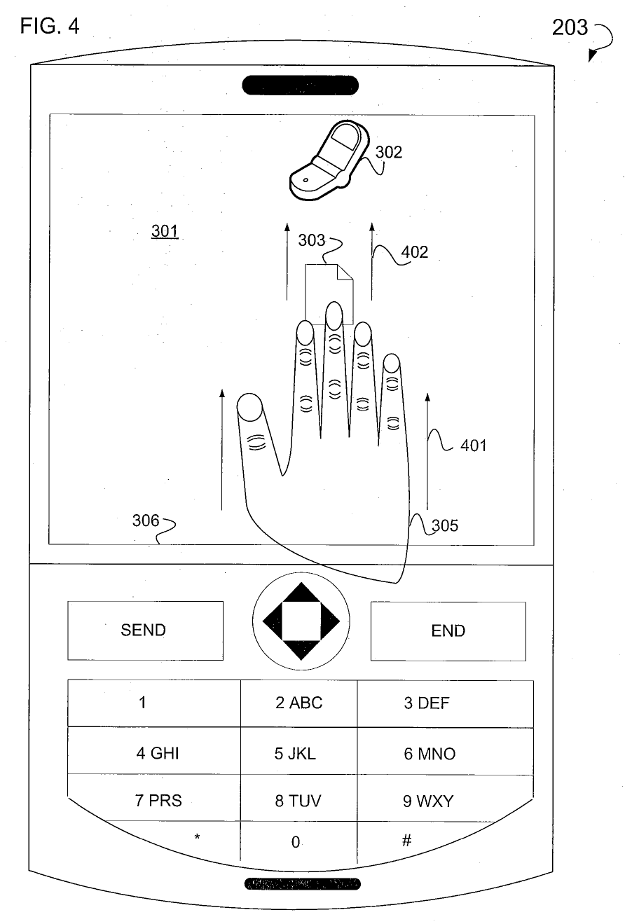

FIG. 4 is a diagram of an example PDA 203 and a palm-push gesture associated therewith to transmit an asset. Shown is a palm-push gesture, where the palm-of the hand 305 is used to push the asset icon 303 towards the icon 302. In some example embodiments, the touch screen 301 receives input from a palm that is part of the hand 305 through the palm engaging the touch screen 301. This palm engages in a palm-push gesture that pushes the asset icon 303 towards the icon 302 representing a device. This direction of the palm-push gesture is denoted by at 401 and 402. Through the use of this palm-push gesture, the asset represented at asset icon 303 is provided to the device 101 represented by the icon 302.

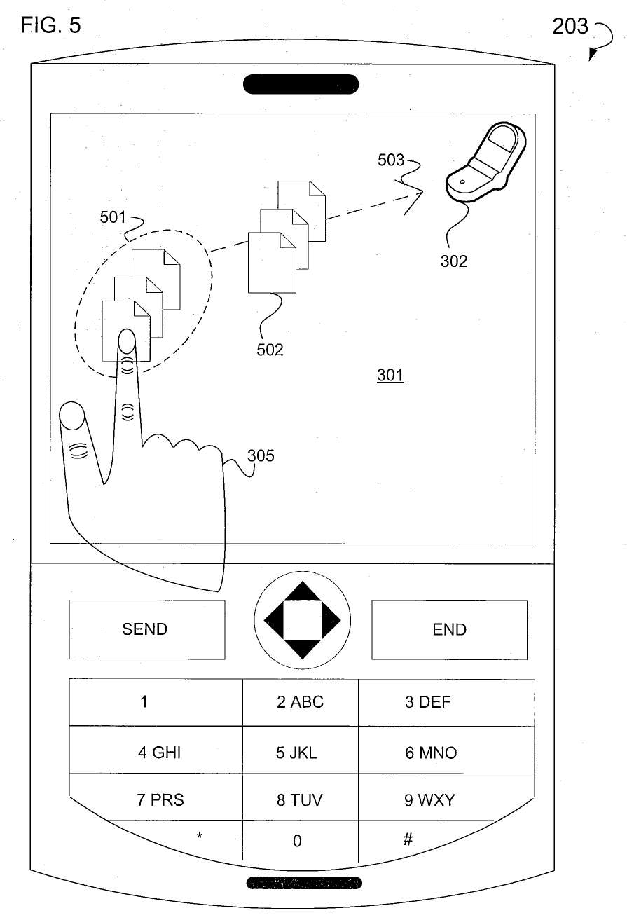

FIG. 5 is a diagram of an example PDA 103 illustrating a flick gesture to transmit an asset to a device. Shown is the hand 305, and a finger associated therewith, that is used to select and flick one or more assets. These assets, represented by the asset icon 502, are transmitted by a flick gesture made in relation to the touch screen 301. Specifically, the finger engages the touch screen 301 with a flicking motion to select and transmit the asset represented by asset icon 502. The selection is denoted at 501. A flick is a light sharp jerky stroke or movement. Through using the flick gesture, the asset 502 is moved along a vector 503. This vector 503 intersects with the icon 302.

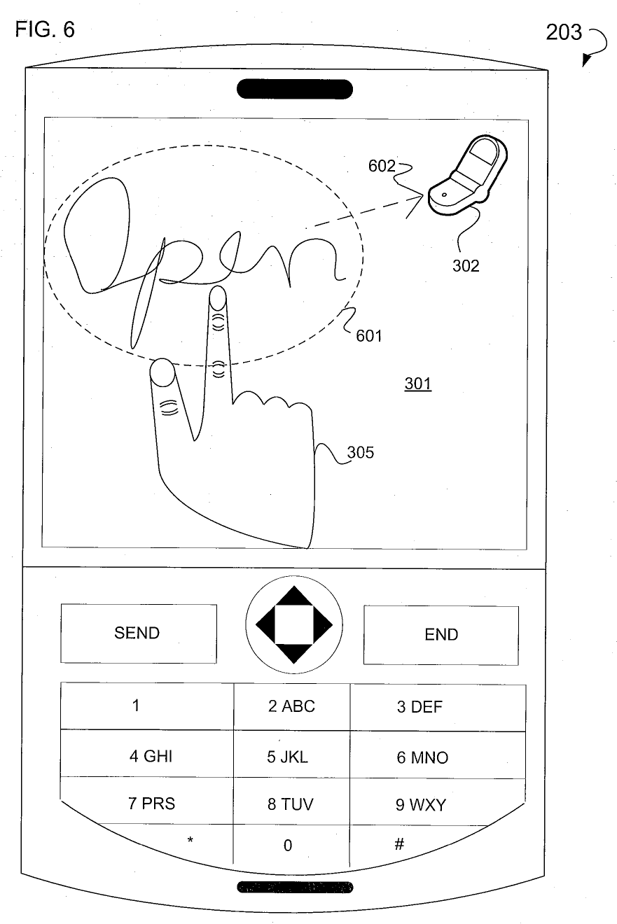

FIG. 6 is a diagram of an example PDA 203 illustrating transmitting graffiti-style text to a device with a graffiti-style gesture. Shown is the hand 305 that is used to generate a graffiti-style text 601 via a graffiti-style gesture. This graffiti-style gesture is generated by a finger associated with the hand 305 engaging the touch screen 301. Graffiti is self styled text generated by a user of the PDA 203. A graffiti-style gesture is a sequence of rapid continuous finger movements that engage the touch screen 301. The graffiti-style text 601 is sent along a vector 602 through a finger associated with a hand 401 engaging the touch screen 301. This graffiti-style text 601 is received by the icon 302. This graffiti-style gesture is received by the touch screen 301 so as to send the text generated through the graffiti-style gesture to the device 101 represented on the touch screen 301 by the icon 302.

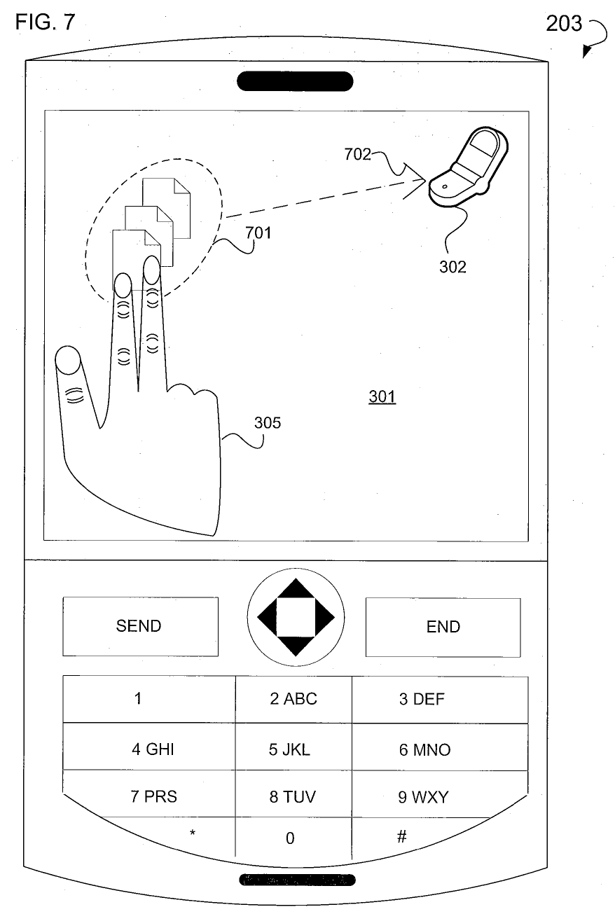

FIG. 7 is a diagram of an example PDA 203 illustrating a two-finger gesture used to transmit an asset to a device. Shown are two fingers of the hand 305 that are used to generate a two-finger gesture to select and transmit an asset to a device. In some example embodiments, two fingers of the hand 305 are used to engage the touch screen 301 to select an asset icon that represents an asset (e.g., a file). The selection is represented at 701. The selected asset icon is sent along a vector 702 by the two-finger gesture such that the asset icon intersects with the icon 302. The asset represented by the asset icon 701 is transmitted to the device represented by the icon 302.

### Example Logic

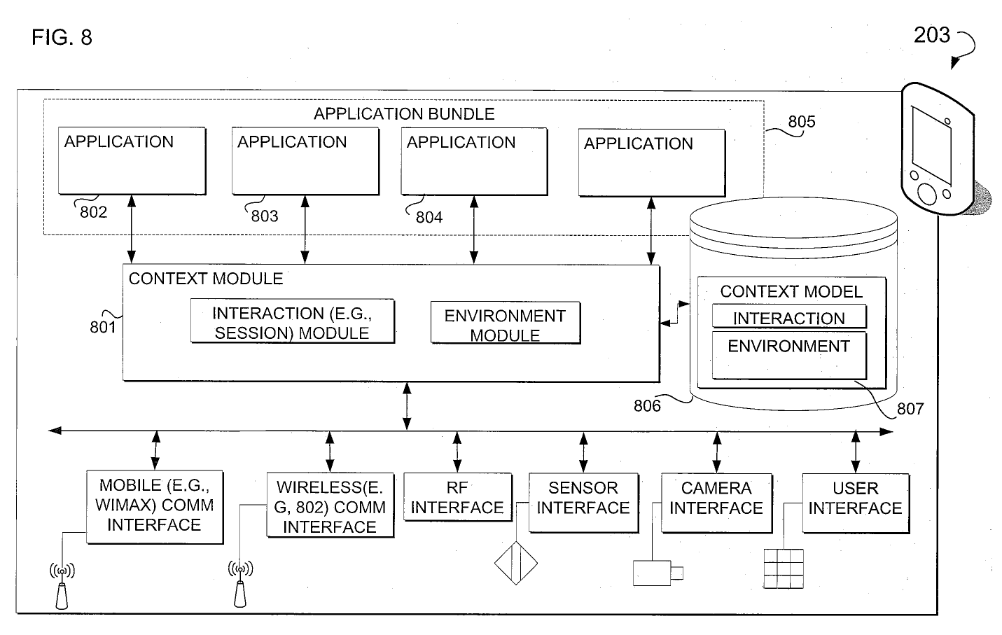

FIG. 8 is a block diagram of an example PDA 203 that includes functionality that enables the PDA 203 to interact with other devices in a context, environment, or session. The various blocks illustrated herein may be implemented by a computer system as hardware, firmware, or software. Shown is a context module 801 that includes an interaction module. This interaction module may be used to establish a session in which devices may participate. Additionally, the context module may include an environment module that is used to generate the environment request 205, and to process the environment 207. Operatively connected to the context module 801 is an application bundle 805 (e.g., a suite of applications). Included in this application bundle 805 are applications 802 through 804. These applications may be used to process assets. Process includes, for example, display, play, record, and/or execute. Example applications include FLASH™ of Adobe Systems, Inc., ACROBAT™ of Adobe Systems, Inc., PHOTOSHOP™ of Adobe Systems, Inc., or some other suitable application. Additionally, operatively connected to the context module 801 is a data store 806 that includes environment data 807 as part of a context model. Included as part of this context model may be session information including a session ID, user ID, and/or device ID. Additionally, included as part of this environment data 807 is the environment 207.

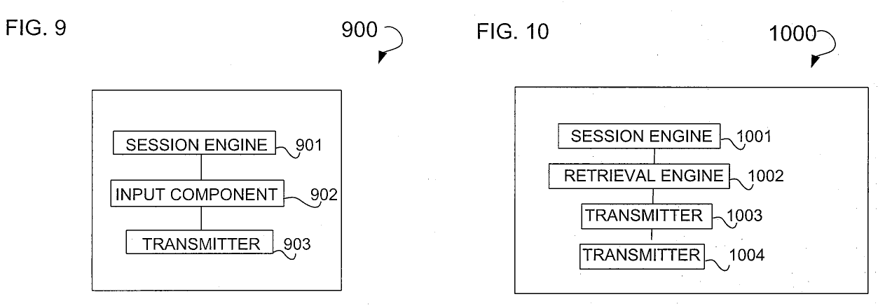

FIG. 9 is a block diagram of an example computer system 900 used to share an asset based upon input in the form of a gesture. The blocks shown herein may be implemented in software, firmware, or hardware. Additionally, these blocks may be processor-implemented blocks in the form of modules or components. These blocks may be directly or indirectly communicatively coupled via a physical or logical connection. The computer system 900 may be the PDA 203 shown in FIG. 2. Shown are blocks 901 through 903. Illustrated is a session engine 901 to allow a first device to join an asset sharing session to access an asset with the first device. Communicatively coupled to the session engine 901 is an input component 902 (e.g., a touch screen) to receive gesture-based input via the first device, the gesture-based input relating to the asset. Communicatively coupled to the input component 902 is a transmitter 903 to share the asset with a second device, participating in the asset sharing session, based on the gesture-based input. The transmitter 903 acts to share the asset with the second device and includes the transmission of the asset to the second device to provide the second device with access, via the asset sharing session, to the asset. In some example embodiments, the first device is provided with access to a first version of the asset and the second device is provided access to a second version of the asset, the first and second versions of the asset being customized to respective first and second contexts within which the first and second devices are operative. Additionally, in some example embodiments, the first device is provided with access to a first version of the asset and the second device is provided access to a second version of the asset, the first and second versions of the asset being customized to respective first and second characteristics of the first and second devices. These first and second characteristics include the type of the first and second device (e.g., a handheld device, television, set-top box). In some example embodiments, the first and second contexts identify an interaction within an environment between the first and second devices, the asset sharing session identified by the environment. Further, the first device may be one of a plurality of devices associated with a first user, the computer system 900 including, responsive to receipt of the gesture-based input, a device recognition engine to recognize the first device of a plurality of devices as being in an active state with respect to the first user. The gesture-based input may include a directional component, the computer system 900 including using the directional component of the gesture-based input to identify the second device. Additionally, the gesture-based input may be received with respect to a visual indicium that represents the second device, displayed on a display of the first device. The gesture-based input may be received with respect to a touch-sensitive display of the first device. Moreover, the gesture-based input may be received by a detection module that detects a predetermined movement of at least a portion of the first device. Additionally, the gesture-based input may be received by a detection module that detects an orientation of the first device.

FIG. 10 is a block diagram of an example computer system 1000 used to distribute an asset based upon the generation of a gesture. The blocks shown herein may be implemented in software, firmware, or hardware. Additionally, these blocks may be processor-implemented blocks in the form of modules or components. These blocks may be directly or indirectly communicatively coupled via a physical or logical connection. The computer system 1000 may be the distribution server 108, application server 119 or some other suitable device shown in FIG. 1. Shown are blocks 1001 through 1004. Illustrated is a session engine 1001 to facilitate participation in an asset sharing session to share an asset based upon a gesture received on a display. Communicatively coupled to the session engine 1001 is a retrieval engine 1002 to retrieve a referent identifying the asset that is to be shared in the asset sharing session. A referent may be a pointer to a location in memory. In some example cases, a Uniform Resource Identifier (URI), such as a Uniform Resource Locator (URL), is used in lieu of, or in combination with the pointer. This URI may be used to retrieve, identify, or access an asset. Communicatively coupled to the retrieval engine 1002 is a transmitter 1003 to transmit the referent that identifies the asset to be shared. In some example embodiments, the referent is received from at least one of a device (e.g., 101 through 107), the distribution server 108, the session management server 114, content server 116, application server 119, or the context server 109. Communicatively coupled to the transmitter 1003 is a further transmitter 1004 to transmit the asset identified by the referent.

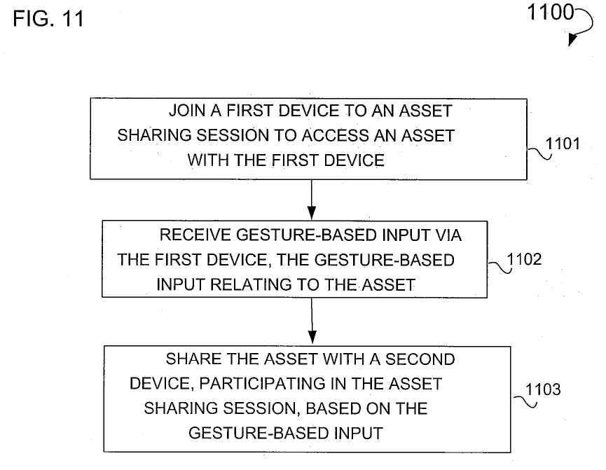

FIG. 11 is a flow chart illustrating an example method 1100 used to share an asset based upon input in the form of a gesture. Shown are various operations 1101 through 1103 that may be executed on the PDA 203 shown in FIG. 2. Operation 1101 is executed by the session engine 901 to joining a first device to an asset sharing session to access an asset with the first device. Operation 1102 is executed by the input component 902 to receive gesture-based input via the first device, the gesture-based input relating to the asset. Operation 1103 is executed by the transmitter 903 to share the asset with a second device, participating in the asset sharing session, based on the gesture-based input. In some example embodiments, the sharing of the asset with the second device includes providing the second device with access, via the asset sharing session, to the asset. In some example embodiments, the first device is provided with access to a first version of the asset and the second device is provided access to a second version of the asset, the first and second versions of the asset being customized to respective first and second contexts within which the first and second devices are operative. Additionally, in some example embodiments, the first device is provided with access to a first version of the asset and the second device is provided access to a second version of the asset, the first and second versions of the asset being customized to respective first and second characteristics of the first and second devices. Further, the first and second contexts identify an interaction within an environment between the first and second devices, the asset sharing session identified by the environment. Moreover, the first device is one of a plurality of devices associated with a first user, the computer-implemented method including, responsive to receipt of the gesture-based input, recognizing the first device of a plurality of devices as being in an active state with respect to the first user. In some example embodiments, a gesture-based input includes a directional component, the computer-implemented method including using the directional component of the gesture-based input to identify the second device. The gesture-based input is received with respect to a visual indicium, representing the second device, displayed on a display of the first device. The gesture-based input is received with respect to a touch-sensitive display of the first device. The gesture-based input is received by detecting a predetermined movement of at least a portion of the first device. In some example embodiments, the gesture-based input is received by detecting an orientation of the first device.

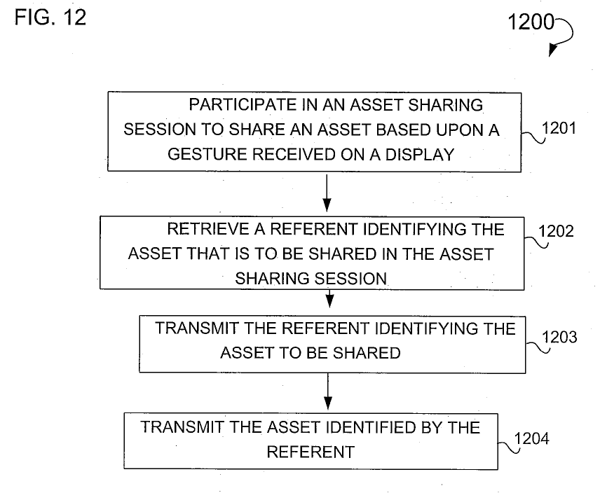

FIG. 12 is a flow chart illustrating an example method 1200 used to distribute an asset based upon a gesture. Shown are various operations 1201 through 1214 that may be executed on the distribution server 108, application server 119 or some other suitable device shown in FIG. 1. An operation 1201 is shown that is executed by the session engine 1001 to facilitate participation in an asset sharing session to share an asset based upon a gesture received on a display. An operation 1202 is executed by the retrieval engine 1002 to retrieve a referent identifying the asset that is to be shared in the asset sharing session. Operation 1203 is executed by the transmitter 1003 to transmit the referent identifying the asset to be shared. In some example embodiments, the referent is received from at least one of a device, a distribution server, a session management server, or a context server. Operation 1204 is executed by the transmitter 1104 to transmit the asset identified by the referent.

In some example embodiments, a method is implemented on a computing platform, the method including executing instructions so that a first device is joined to a asset sharing session to access a digital asset with the first device. The method further including executing instructions on the computing platform so that gesture-based input is received via the first device, the gesture-based input relating to the digital asset. Additionally, the method includes executing instructions on the computing platform so that the digital asset is shared with a second device participating in the asset sharing session, based on the gesture-based input.

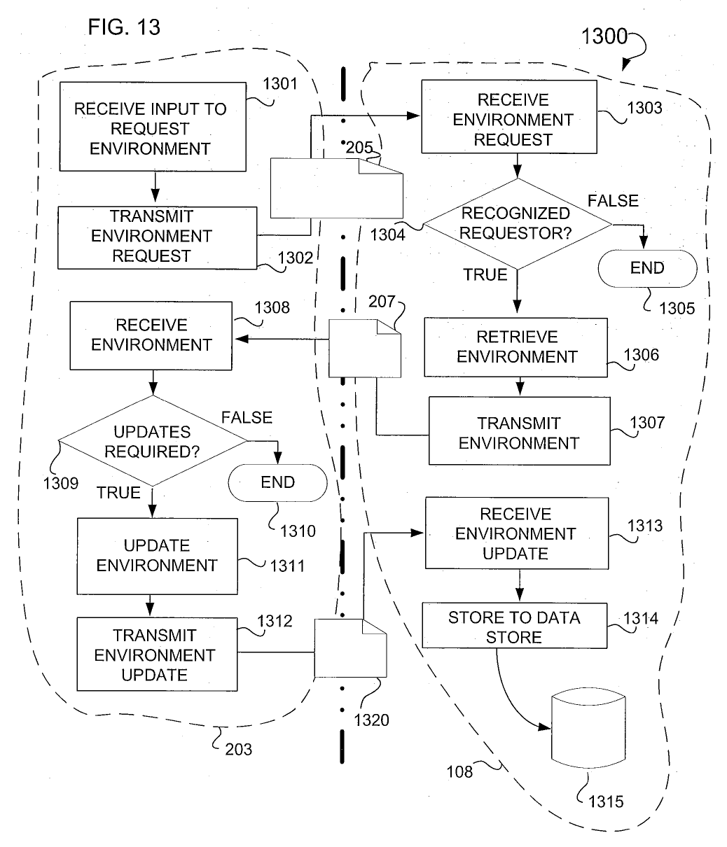

FIG. 13 is a dual-stream flow chart illustrating an example method 1300 used to request and receive an environment, and to generate an environment update. Shown are operations 1301 through 1302, and 1308 through 1312. These various operations may be executed by the cell phone 101, or other suitable device that interacts in a context. Also shown are operations 1303 through 1307, and 1313 through 1314. These various operations are executed within the network 113 and the various servers (e.g., 108, 114, 109, and 116) illustrated therein. For example, the distribution server 108 may execute these various operations 1303 through 1307, and 1313 through 1314. Shown is an operation 1301 that, when executed, receives input to request an environment. This input may be generated by an input device such as a touch screen, mouse, keyboard, light pen, or other suitable input device. Operation 1302 is executed to transmit the environment request 205. Operation 1303, when executed, receives the environment request 205. Decisional operation 1304 is executed to determine whether the device, and user associated therewith, is recognized as being able to request an environment. Where decisional operation 1304 evaluates to “false,” a termination condition 1305 is executed as the requesting device or user is unrecognized. In cases where decisional operation 1304 evaluates to “true,” an operation 1306 is executed. Operation 1306, when executed, retrieves an environment from, for example, the context server 109 and data store associated therewith (not pictured). Operation 1307 is executed to transmit the environment 207. Operation 1308 is executed to receive the environment 207. In some example embodiments, the operation 1308 is executed by one of more of the interfaces shown in FIG. 8. A decisional operation 1309 is executed to determine whether an update of the environment 207 is required. In cases where decisional operation 1309 evaluates to “false,” a termination condition 1310 is executed. In cases where decisional operation 1309 evaluates to “true,” an operation 1311 is executed. Operation 1311 is executed to update the environment 207. This update may include additional location information relating to the cell phone 101, or other device participating in the context 122. Operation 1312 is executed to transmit an environment update 1320. This environment update 1320 is received through the execution of operation 1313. Operation 1314 is executed to store the environment update 1320 into a data store 1315.

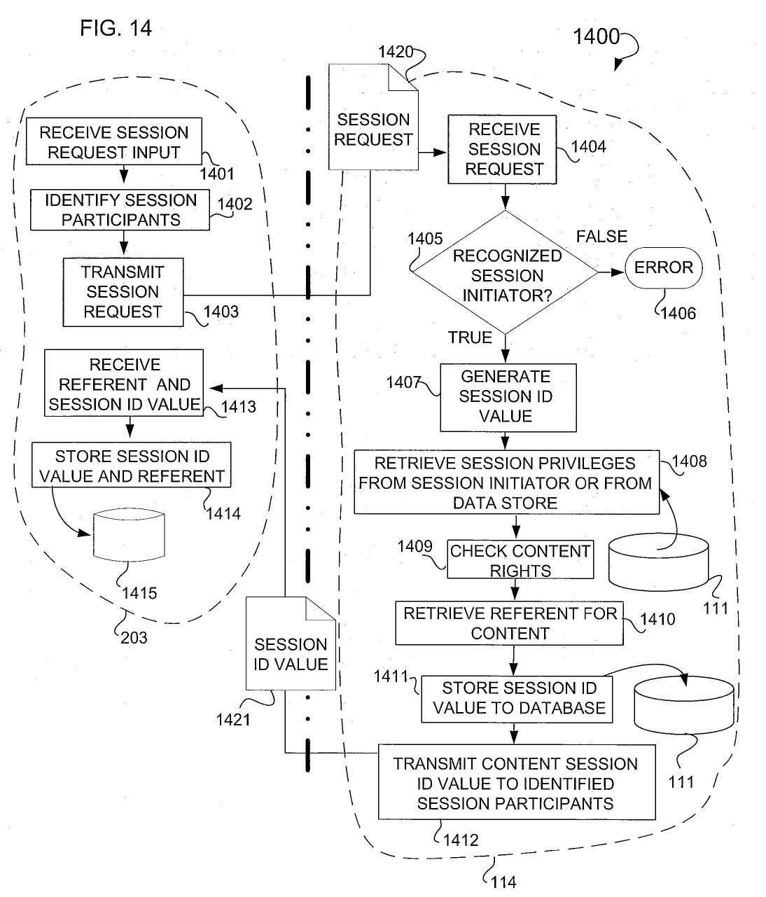

FIG. 14 is a dual-stream flow chart illustrating a method 1400 used for the establishment of an asset sharing session. Shown are various operations 1401 through 1403, and 1413 through 1414 that are executed by the PDA 203. Further, shown are various operations 1404 through 1412 that are executed by the session management server 114. Illustrated is an operation 1401 that, when executed, receives a session request input. This input may be generated through the use of a mouse, light pen, touch screen, keyboard, or other suitable input device. An operation 1402 is executed to identify session participants. These session participants may be the devices 101 through 104, and/or the users associated with these devices 101 through 104. An operation 1403 is executed to transmit the session request 1420 across the network 113. An operation 1404 is executed to receive this session request 1420. A decisional operation 1405 is executed to determine whether the session initiator (e.g., the device or person as identified via a device ID, and/or user ID) may establish a session. In cases where decisional operation 1405 evaluates to “false,” an error condition 1406 is noted. In cases where decisional operation 1405 evaluates to “true,” an operation 1407 is executed that generates a session ID value. Operation 1408 is executed to retrieve session privileges from the session initiator (e.g., the PDA 203 and/or the associated user), or from the database 111. An operation 1409 is executed that checks the content rights associated with the session initiator. Operation 1410 is executed to retrieve a referent for content. This referent may be retrieved from the content server 116. An operation 1411 is executed to store the session ID value to the database 111. An operation 1412 is executed to transmit the content session ID value to the identified session participants and/or the session initiator. This session ID value 1421 is received through the execution of operation 1413. The session ID value 1421 may further include the retrieved referent to the content (see e.g., operation 1410). Operation 1414 is executed to store the session ID value and referent into a data store 1415 that may reside natively or non-natively on the device 203.

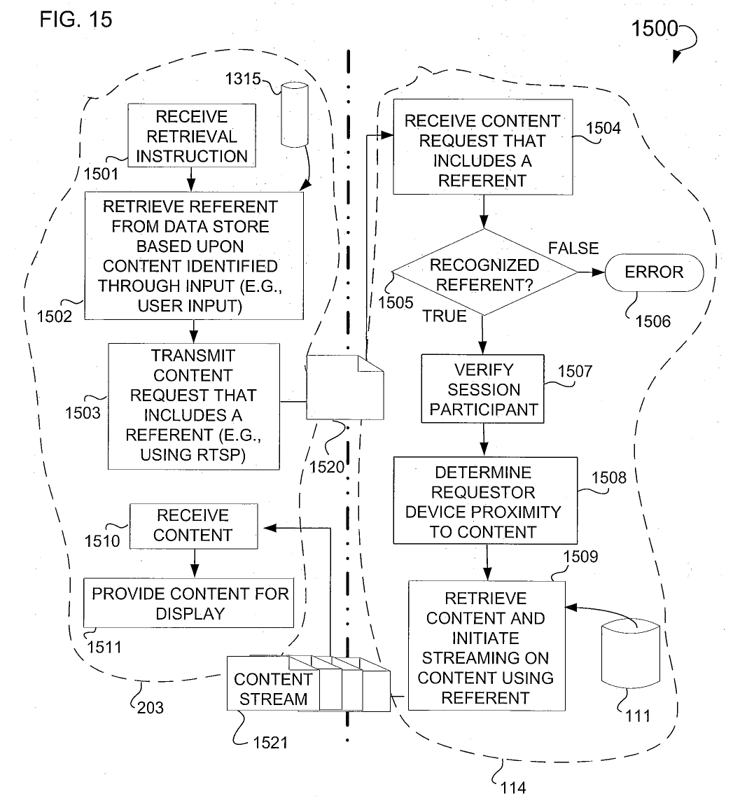

FIG. 15 is a dual-stream flow chart illustrating a method 1500 used to facilitate content streaming as part of an asset sharing session. Shown are operations 1501 through 1503, and 1510 through 1511 that reside upon, or that are otherwise are executed by the PDA 203. Further, shown are operations 1504 through 1509 that are executed by or otherwise reside upon the session management server 114. Shown is an operation 1501 that is executed to retrieve retrieval instructions. These retrieval instructions may be automatically retrieved by the PDA 203, or made may retrieved as the result of user input. Further, an operation 1502 is executed to retrieve a referent from a data store 1315 based upon certain identified content. An operation 1503 is executed to transmit a content request that includes the referent. This content request may be the content request 1512. Operation 1504, when executed, receives the content request 1512. Decisional operation 1505 is executed to determine whether or not the referent is recognized. A recognized referent is one that has been allocated by, for example, the server management server 114 or content server 116 for the purposes of accessing content. In cases where decisional operation 1505 evaluates to “false,” an error condition is noted. In cases where decisional operation 1505 evaluates to “true,” an operation 1507 is executed. Operation 1507, when executed, verifies the session participant (e.g., the PDA 203 and/or the user associated with the PDA 203). Operation 1508 is executed to determine the requestor's device proximity to the content. Specifically, operation 1508 determines the proximity of, for example, the device 203 to the location of the content to be streamed to the device 203. Operation 1509 is executed to retrieve content from the database 115, and to initiate streaming. Operation 1510 is executed to receive the content stream 1513. Operation 1511 is executed that provides the content for, for example, display on the PDA 203 (e.g., touch screen logic). In some example embodiments, the content stream 1513 is stored into the data store 1315 for future viewing or use. In some example embodiments, a software component is provided in lieu of the content stream 1513 such that a software component is retrieved through the execution of operation 1509 and transmitted to the device 203. This software component may be stored into the data store 1315 for current or future use.

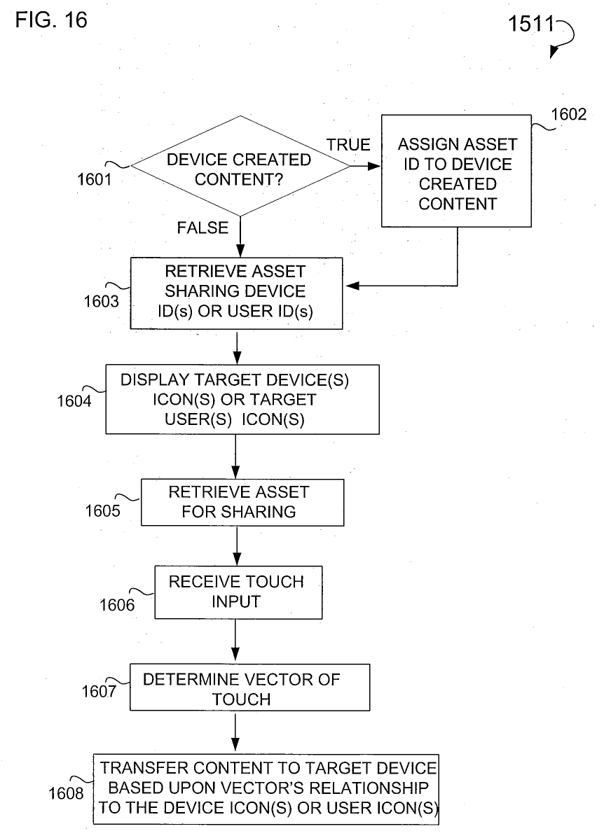

FIG. 16 is a flow chart illustrating the example execution of an operation 1511 that provides an asset for display or processing. Shown is a decisional operation 1601 that determines whether a device has created content. In cases where decisional operation 1601 evaluates to “true,” an operation 1602 is executed. In cases where decisional operation 1601 evaluates to “false,” an operation 1603 is executed. Operation 1602 assigns an asset ID to device created content, where this content ID is a unique identifier used to uniquely identify the content generated by the device. This content may be in the form of, for example, the graffiti-style text 601, or some other suitable type of content generated by a device. Operation 1603 is executed to retrieve a content sharing device ID, or a user ID. In some example embodiments, this content sharing device ID, or user ID corresponds to the device represented by the icon 401 (e.g., the device 101). Operation 1604 is executed to display a target device icon, or a target user icon in the form of the icon 402. A target user icon is an icon representing a user (e.g., an avatar). Operation 1605 is executed to retrieve an asset for sharing, where the asset may be visual content or an application. Operation 1606 is executed that receives touch input where this touch input may be one or more of the gestures illustrated in FIGS. 3 through 7. Operation 1607 is executed that determines the vector of the touch where this vector may be, for example, the vectors 503, 602 or 702. Operation 1608 is executed that transfers content to a target device based upon the vector's relationship to the device's icon or a user icon, and the intersection of the asset icon and the device icon along the vector.

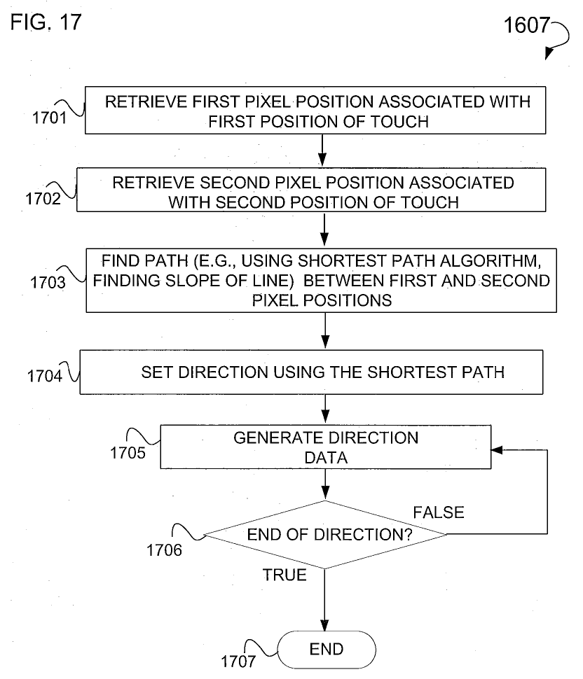

FIG. 17 is a flow chart illustrating an example operation 1607. Shown is an operation used to determine the vector of an asset icon (e.g., 303, 502, 601, or 701) on a display. Illustrated is an operation 1701 that is executed to retrieve a first pixel position associated with a first position of input on a touch screen. Operation 1702 is executed to retrieve a second pixel position of input on a touch screen. Operation 1703 is executed to find a path between the first and second pixel positions. This path may be found by finding the slope of a line of pixels between the first and second pixel positions. This path may be found through treating the first and second pixel positions as nodes in a graph, and finding the shortest path between the first and second pixel positions using a shortest path algorithm. Some shortest path algorithms include Dijkstra's algorithm, Floyd's algorithm, or some other suitable shortest path algorithm. Operation 1704 is executed to set the direction of the vector using the shortest path. For example, if the shortest path is composed of a sequence of adjacent pixels, this sequence is used to define the direction of the vector. Additionally, the slope of a line may be defined in terms of pixels denoting rise over run. Operation 1705 is executed generate direction of data. Decisional operation 1706 is executed to determine whether the end of the direction for (e.g., the path) has been met. In cases where decisional operation 1706 evaluates to “false,” operation 1705 is re-executed. In cases where decisional operation 1706 evaluates to “true,” a termination condition 1707 is executed. An end of direction may be in the form of the asset icon 302.

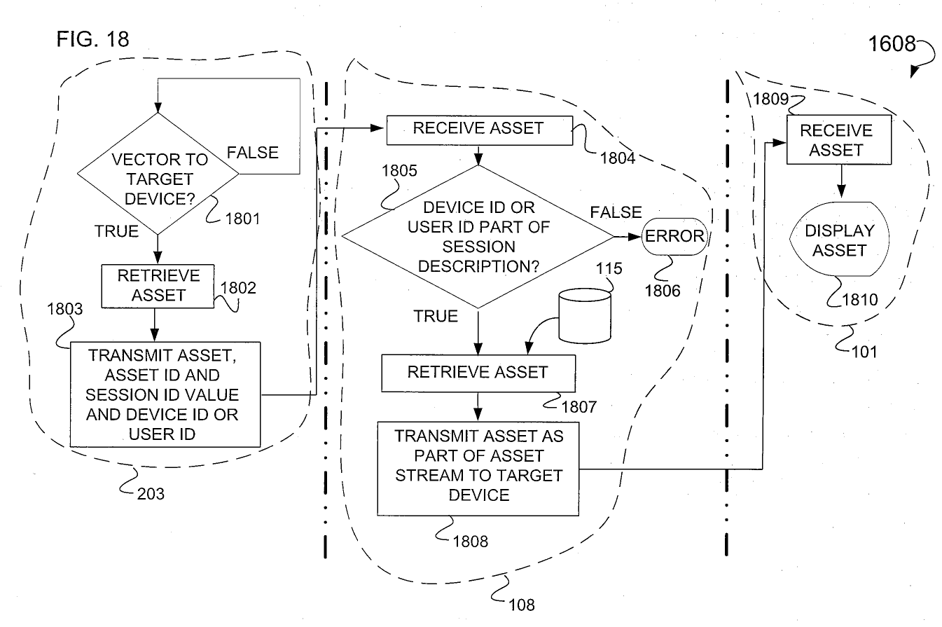

FIG. 18 is a tri-stream flow chart illustrating the execution of an example operation 1608. Shown is a decisional operation 1801, and operation 1802 through 1803 that reside upon, or are otherwise are executed by the PDA 203. Also shown are operations 1804 through 1808 that are executed by, or otherwise reside upon, the distribution server 108. Further shown are operations 1809 and 1810 that are executed by, or otherwise reside upon, the cell phone 101. Illustrated is a decisional operation 1801 that determines the vector to a target. In cases where decisional operation 1801 evaluate to “false,” decisional operation 1801 is re-executed. In cases where decision operation 1801 evaluates to “true,” an operation 1802 is executed. Operation 1802 is executed to retrieve an asset. An operation 1803 is executed to transmit the asset, an asset ID, a session ID value and a device ID or user ID value. Operation 1804 is executed that receives the transmitted asset, asset ID, device ID, and session ID. A decisional operation 1805 is executed that determines whether the device ID or user ID is a part of a session description. In cases where decisional operation 1805 evaluates to “false,” a termination condition 1806 is executed. In cases where decisional operation 1805 evaluates to “true,” an operation 1807 is executed. Operation 1807, when executed, retrieves an asset from the content server 116 or the application server 119. An operation 1808 is executed that transmits this content as part of the content stream to target device. This content stream may be the content stream 1521. Operation 1809 is executed that receives an asset, and an operation 1810 is executed that displays the asset. In some example embodiments, in lieu of operation 1810 so other operation is used to process the asset (e.g., play, execute etc.)

### Example Database

Some embodiments may include the various databases (e.g., ) being relational databases, or, in some cases, On Line Analytic Processing (OLAP)-based databases. In the case of relational databases, various tables of data are created and data is inserted into and/or selected from these tables using a Structured Query Language (SQL) or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 8I™, 10G™, or some other suitable database application may be used to manage the data. In this, the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

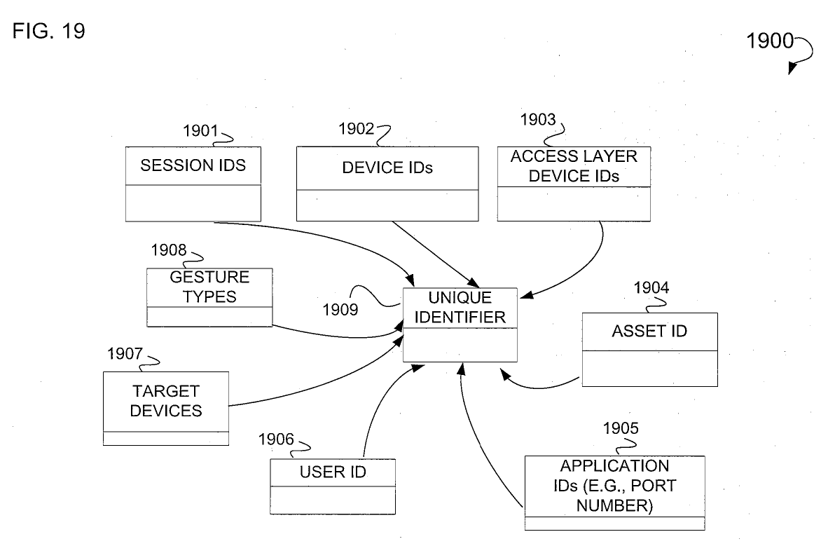

FIG. 19 is an example Relational Data Schema (RDS) 1900. Shown is a table 1901 that includes session IDs. These session IDs may be a Globally Unique IDentifier (GUID) used to uniquely identify a session in which devices and/or users participate. A long integer data type or some other suitable data type may be used to store-session IDs into a table 1901. Table 1902 includes device IDs, where these device IDs may be stored as an integer, or long integer data type that may be used to uniquely identify a device through its Media Access Control (MAC), Electronic Serial Number (ESN), or through some other suitable type of device identifier. Table 1903 includes an access layer device IDs. These access layer device IDs may be stored as an integer, long integer data type, and may be used to identify an access layer device, such as access layer device 106. Table 1904 includes asset IDs, where these asset IDs may be an integer used to uniquely identify a particular asset or piece of an asset. Table 1905 is shown that includes application IDs, where the application IDs may be stored as an integer data type used to uniquely identify an application. A port number may be an example of an application ID. Table 1906 is shown that includes user IDs. These user IDs may be some type of unique identifier value stored as an integer data type. Table 1907 includes the list of potential target devices. This list maybe stored as eXtensible Markup Language (XML), or other suitable data type in where these target devices are identified as part of an environment. Table 1908 includes gesture types, where these gesture types may be stored as an XML data type used to describe various types of input to be received by the touch screen 401. A table 1909 is shown that includes unique identifiers used to uniquely identify each of the entries in the tables 1901 through 1908. This unique identifier can be stored as an integer data type.

### Distributed Computing Components and Protocols

Some example embodiments may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

### A Computer System

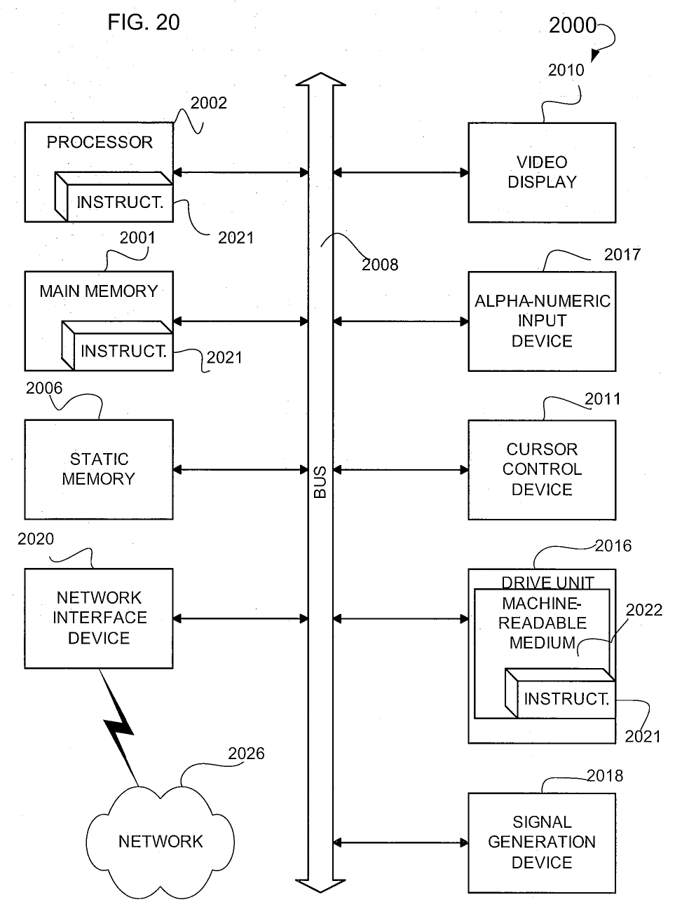

FIG. 20 shows a diagrammatic representation of a machine in the example form of a computer system 2000 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a Personal Computer (PC), a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 2000 includes a processor 2002 (e.g., a CPU, a Graphics Processing Unit (GPU) or both), a main memory 2001, and a static memory 2006, which communicate with each other via a bus 2008. The computer system 2000 may further include a video display unit 2010 (e.g., a Liquid Crystal Display (LCD) or a Cathode Ray Tube (CRT)). The computer system 2000 also includes an alphanumeric input device 2017 (e.g., a keyboard), a User Interface (UT) (e.g., GUT) cursor controller 2011 (e.g., a mouse), a drive unit 2016, a signal generation device 2018 (e.g., a speaker) and a network interface device (e.g., a transmitter) 2020.

The disk drive unit 2016 includes a machine-readable medium 2022 on which is stored one or more sets of instructions and data structures (e.g., software) 2021 embodying or used by any one or more of the methodologies or functions illustrated herein. The software instructions 2021 may also reside, completely or at least partially, within the main memory 2001 and/or within the processor 2002 during execution thereof by the computer system 2000, the main memory 2001 and the processor 2002 also constituting machine-readable media.

The instructions 2021 may further be transmitted or received over a network 2026 via the network interface device 2020 using any one of a number of well-known transfer protocols (e.g., Hyper Text Transfer Protocol (HTTP), Secure Hyper Text Transfer Protocol (HTTPS)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).).

1. A computer-implemented method comprising:
joining a first device to an asset sharing session to access a first version of an asset with the first device, the first version of the asset being customized to a first location at which the first device is located;
receiving gesture-based input via the first device, the gesture-based input indicating an asset icon that represents the asset and indicating a direction of a flick from the asset icon towards a device icon that is displayed on a display of the first device and that represents a second device in the asset sharing session, the receiving of the gesture-based input being performed by a processor of a machine; and
providing the second device in the asset sharing session with access to a second version of the asset, the second version of the asset being customized to a second location at which the second device is located, the providing being based on the gesture-based input that indicates the direction of the flick from the asset icon towards the device icon that represents the second device.

2. The computer-implemented method of claim 1, wherein the first location is in a physical structure.

3. The computer-implemented method of claim 1, wherein the first device is provided with access to the first version of the asset and the second device is provided access to the second version of the asset, the first and second versions of the asset being customized to respective first and second contexts within which the first and second devices are operative.

4. The computer-implemented method of claim 1, wherein the first device is provided with access to the first version of the asset and the second device is provided access to the second version of the asset, the first and second versions of the asset being customized to respective first and second characteristics of the first and second devices.

5. The computer-implemented method of claim 3, wherein the first and second contexts identify an interaction within an environment between the first and second devices, the asset sharing session identified by the environment.

6. The computer-implemented method of claim 1, wherein the first device is one of a plurality of devices associated with a first user, the computer-implemented method including, responsive to receipt of the gesture-based input, recognizing the first device of a plurality of devices as being in an active state with respect to the first user.

7. The computer-implemented method of claim 1, wherein the gesture-based input includes a directional component, the computer-implemented method including using the directional component of the gesture-based input to identify the second device.

8. (canceled)

9. The computer-implemented method of claim 1, wherein the gesture-based input is received with respect to a touch-sensitive display of the first device.

10. The computer-implemented method of claim 1, wherein the gesture-based input is received by detecting a predetermined movement of at least a portion of the first device.

11. The computer-implemented method of claim 1, wherein the gesture-based input is received by detecting an orientation of the first device.

12. A computer system comprising:
a session engine configured to allow a first device to join an asset sharing session and to access a first version of an asset with the first device, the first version of the asset being customized to a first location at which the first device is located;
a processor configured by a input component that configures the processor to receive gesture-based input at the first device, the gesture-based input indicating an asset icon that represents the asset and indicating a direction of a flick from the asset icon towards a device icon that is displayed on a display of the first device and that represents a second device in the asset sharing session; and
a transmitter configured to provide the second device in the asset sharing session with access to a second version of the asset, the second version of the asset being customized to a second location at which the second device is located, the access to the second version being provided based on the gesture-based input that indicates the direction of the flick from the asset icon towards the device icon that represents the second device.

13. The computer system of claim 12, wherein the transmitter to share the asset with the second device is to transmit to the asset to the second device so as to provide the second device with access, via the asset sharing session, to the asset.

14. The computer system of claim 12, wherein the first device is provided with access to the first version of the asset and the second device is provided access to the second version of the asset, the first and second versions of the asset being customized to respective first and second contexts within which the first and second devices are operative.

15. The computer system of claim 12, wherein the first device is provided with access to the first version of the asset and the second device is provided access to the second version of the asset, the first and second versions of the asset being customized to respective first and second characteristics of the first and second devices.

16. The computer system of claim 14, wherein the first and second contexts identify an interaction within an environment between the first and second devices, the asset sharing session identified by the environment.

17. The computer system of claim 12, wherein the first device is one of a plurality of devices associated with a first user, the computer system including a device recognition engine to recognize the first device of a plurality of devices as being in an active state with respect to the first user, responsive to receipt of the gesture-based input.

18. The computer system of claim 12, wherein the gesture-based input includes a directional component, the computer system to use the directional component of the gesture-based input to identify the second device.

19. The computer system of claim 12, wherein the input component is a display of the first device.

20. The computer system of claim 12, wherein the display of the first device is a touch-sensitive display.

21. The computer system of claim 12, wherein the input component is a processor-implemented motion detection module of the first device, and wherein the gesture-based input is received by the processor-implemented motion detection module, the processor-implemented motion detection module is to detect predetermined movement of at least a portion of the first device.

22. The computer system of claim 21, wherein the processor-implemented motion detection module is to detect an orientation of the first device.

23. A computer-implemented method comprising:
executing instructions on a computing platform so that a first device is joined to an asset sharing session to access a first version of a digital asset with the first device, the first version of the digital asset being customized to a first location at which the first device is located;
executing instructions on the computing platform so that gesture-based input is received via the first device, the gesture-based input indicating an asset icon that represents the asset and indicating a direction of a flick from the asset icon towards a device icon that is displayed on a display of the first device and that represents a second device in the asset sharing session, the receiving of the gesture-based input being performed by a processor of the computing platform; and
executing instructions on the computing platform so that access to a second version of the digital asset is provided to the second device that is participating in the asset sharing session, the second version of the asset being customized to a second location at which the second device is located, the access to the second version being provided based on the gesture-based input that indicates the direction of the flick from the asset icon towards the device icon that represents the second device.

24. A non-transitory machine-readable medium comprising instructions that, when executed by one or more processors of a machine, cause the machine to perform operations comprising:
joining a first device to an asset sharing session to access a first version of an asset with the first device, the first version of the asset being customized to a first location at which the first device is located;
receiving gesture-based input via the first device, the gesture-based input indicating an asset icon that represents the asset and indicating a direction of a flick from the asset icon towards a device icon that is displayed on a display of the first device and that represents a second device in the asset sharing session, the receiving of the gesture-based input being performed by the one or more processors of the machine; and
providing the second device in the asset sharing session with access to a second version of the asset, the second version of the asset being customized to a second location at which the second device is located, the providing being based on the gesture-based input that indicates the direction of the flick from the asset icon towards the device icon that represents the second device.
